(19) United States
(12) Patent Application Publication
(10) Pub. No.: US 2009/0064975 A1
(43) Pub. Date: Mar. 12, 2009

(54) TWO-STROKE COMBUSTION ENGINE

(76) Inventor: Mats Hedman, Eskilstuna (SE)

Correspondence Address: KEVIN FARRELL;PIERCE ATWOOD, ONE NEW HAMPSHIRE AVENUE, PORTSMOUTH, NH, 03801, US

(21) Appl. No.: 12/161,339

(22) PCT Filed: Jan. 31, 2007
(86) PCT No.: PCT/SE2007/050048

§ 371 Date: Nov. 6, 2008

(30) Foreign Application Priority Data
Jan. 31, 2006 (SE) 0600197-8

(51) Int. Cl. F02B 25/00

(52) U.S. Cl. 123/65 R

(57) ABSTRACT

A method for the operation of a combustion engine operating in accordance with a two stroke principle, which comprises alternating power stroke and compression strokes, wherein the combustion engine comprises at least one cylinder (1) and a piston (2) that moves reciprocatingly therein, and a combustion chamber delimited (3) by the cylinder (1) and the piston (2), and at least one inlet (13) for the introduction of combustion air into the combustion chamber (3), and at least one outlet (14) having freely operable outlet valve (5) for the discharge of exhaust gases from the combustion chamber (3). The outlet valve (5) is kept open during at least a part of a compression stroke.

### TECHNICAL FIELD

The present invention relates to a method of operating a combustion engine operating in accordance with the two stroke principle, comprising alternating power strokes and compression strokes, wherein the combustion engine comprises at least one cylinder and a piston performing a reciprocating motion therein, and a combustion chamber delimited by the cylinder and the piston, and at least one inlet for the introduction of combustion air into the combustion chamber, and at least one outlet provided with a freely operable outlet valve for the discharge of exhaust gases from the combustion chamber.

The invention also relates to a combustion engine operating in accordance with the two stroke principle, said principle comprising alternating power strokes and compression strokes, wherein the combustion engine comprises at least one cylinder and a piston that performs a reciprocating motion in said cylinder, and a combustion chamber delimited by said cylinder and piston, and at least one inlet for the introduction of combustion air into the combustion chamber, and at least one outlet provided with a freely operable outlet valve for the discharge of exhaust gases from the combustion chamber.

Preferably also the inlet is provided with a freely operable valve, but may only be provided with an inlet port which is opened and closed by the passing piston, said port being provided in the cylinder wall, preferably in the area of the lower dead centre of the piston. The freely operable valves are, suitably, controlled by a computer-based control system which, for example, may form part of an already existing control system used for the control of the ignition and the injection of fuel, water, water steam, etc., into the combustion chamber. The freely operable valves may be driven by means of pressure fluid, preferably pneumatically driven. The control system may comprise a control unit through which control signals are transmitted to pilot valves that control the flow of a pressure fluid in a pressure fluid circuit, in which circuit there are provided pressure fluid-activated actuators that, through the action of the pressure fluid, drives the freely operable valves, i.e. the outlet valves and possibly also the inlet valves of the combustion engine.

In said cylinder the piston moves reciprocatingly between two end positions, an upper dead centre and a lower dead centre respectively. The path from the upper dead centre to the lower dead centre is referred to as a power stroke, and path of the piston from the lower to upper dead centre is referred to as a compression stroke. When the engine operates, combustion is initiated in connection with the ending of the compression stroke, and the evacuation of the combustion gases starts in connection with the ending of the power stroke.

### THE BACKGROUND OF THE INVENTION

Contemporary two stroke engines usually use ports for the evacuation of exhaust gases and for the introduction of new air, said ports being exposed in connection with the lower dead centre of the piston. A disadvantage of this technique is that, when the piston and its piston rings passes said ports, oil will be scraped of against the edges of the ports and will follow the exhaust gases during the evacuation thereof. Another disadvantage appears in those cases when the piston is used as a scavenging pump, wherein oil from the crankcase will follow the air that is to take part in the combustion. Contemporary requirement, and in particular the requirements of the future on low exhaust gas emissions may not be possible to achieve due to said disadvantages. It is common knowledge that freely operable poppet valves in the cylinder head in combination with a scavenging pump driven by the engine shaft could solve said problem. It is also common knowledge that a scavenging pump is only necessary during start of the engine and during acceleration after motor braking, but that, for the rest of the time it could be shut off and replaced by the dynamic effects that are generated in the cylinder when the exhaust gases are evacuated. If these dynamic effects could be used also during start of the engine and during acceleration after motor braking, and, therefore, there would not be any need of the scavenging pump, the efficiency of the engine could be improved and the costs of the engine could be lowered.

### OBJECT OF THE INVENTION

The object of the present invention is to improve the preconditions for the utilizing of a dynamic effect for the gas exchange in the combustion chamber of a combustion engine, for operative conditions when these preconditions are normally unsatisfying. Such operative conditions may, for example, include start of the engine, and acceleration after motor braking, in which, normally a scavenging pump would be necessary for the accomplishment of a sufficient gas exchange in the combustion chamber. Gas exchange if referred to as the discharge of exhaust gases and the introduction of new combustion air.

In other words, the object of the invention is to generate a dynamic effect under certain conditions, such as during start of the engine and during acceleration after motor braking, where, normally, a scavenging pump would have been required in order to introduce a sufficient amount of fresh air through the inlet channel, in order, thereby, to create a pressure relation between the combustion chamber and the inlet channel that makes any scavenging pump unnecessary.

### SUMMARY OF THE INVENTION

The object of the invention is achieved by means of the initially defined method for two stroke combustion engines, said method being characterized in that the outlet valve is kept open during at least a part of a compression stroke, and in that the closure of the outlet valve is performed at such a late stage during the compression stroke that there is generated a negative pressure in the combustion chamber in relation to the pressure in the inlet channel during the subsequent power stroke. Thanks to the invention a negative pressure, in relation to the pressure in the inlet channel, is obtained in the combustion chamber during the subsequent power stroke following said compression stroke. This negative pressure can be taken advantage of in order to provide for a rapid introduction of a sufficient amount of combustion air during said power stroke. The cycle during which the inventive sequence is performed takes place without any ignition or combustion, and there is no actual work being performed during the power stroke in question. During a subsequent cycle, and also during the following cycles, when a sufficient amount of fresh air has been introduced thanks to the inventive sequence, ignition and combustion is performed as usually. In other words, the invention comprises a temporary delay of the closure of the outlet valve during a stroke, in order to provide for a precondition caused by the relative negative pressure in the combustion chamber, for a sufficient introduction of air into the combustion chamber without the aid of any scavenging pump. It should be realized that the inventive sequence primarily, is conceived to be applied only during the operational sequences in which a scavenging pump otherwise would have been necessary.

According to a preferred embodiment, the outlet valve is closed during the later half of said compression stroke, that is during the last 90 crank angle degrees before the piston reaches its upper dead centre (there are 180 crank angle degrees between the lower and upper dead centres of the piston). Accordingly, a relatively large negative pressure can be obtained in the combustion chamber during the subsequent power stroke, thereby promoting a rapid introduction of combustion air.

Preferably, the outlet valve is closed during the last quarter of said compression stroke, and most preferably the outlet valve is closed at the end of said compression stroke, preferably during the last 20, or even more preferably during the last 10 crank angle degrees before the moment when the piston reaches its upper dead centre. Accordingly, a maximum negative pressure is obtained in the combustion chamber during the subsequent power stroke.

Moreover, it is preferred that the outlet valve be opened at the beginning of said compression stroke, preferably during the first 45 crank angle degrees during the motion of the piston towards its upper dead centre. At this stage there is a minimum pressure in the combustion chamber, and minimum of work is required in order to open the valve, presumed that the valve is of a type that, from a valve seat, is displaced into the combustion chamber in connection to the opening thereof.

According to the invention, the inlet for the introduction of air into the combustion chamber is opened during the power stroke that follows said compression stroke. Preferably the opening is temporary during that part of the power stroke when the negative pressure is at a maximum in the combustion chamber, i.e. at the end of the power stroke, preferably during the last 45 crank angle degrees before the piston reaches its lower dead centre. In order to obtain the maximum effect, the inlet is closed at the moment when the flow of air into the combustion chamber spontaneously ends. This may occur either at the end of the power stroke or at the beginning of the subsequent compression stroke. At low rotational speeds it is also possible that the opening of the inlet is to be performed as late as at the beginning of said compression stroke following said power stroke. In other words, it is preferred to temporarily open the inlet during a crank angle range close to the lower dead centre of the piston, when the negative pressure in the cylinder is at its minimum. In order to enable variations of the timing of the opening and closure of the inlet, the latter is preferably provided with a freely operable valve, similar to the one of the outlet.

According to the invention, the outlet valve is kept open during at least a part of a compression stroke in connection with operational conditions during which an improvement of the preconditions for a dynamic effect for the gas exchange in the combustion chamber is to be achieved. According to a preferred embodiment of the invention, said operational condition includes at least one of the conditions that include start of the engine or acceleration thereof subsequent to motor braking. The discharge of gases out of the combustion chamber during the compression stroke will, in other words, take place under predetermined conditions, whereafter the engine may return to the normal opening and closure sequence for the outlet valves.

Furthermore, it is preferred that said valves be operated by means of pneumatic. It is also preferred that they be positioned in the cylinder head and opened by means of a displacement into the combustion chamber.

The object of the invention is also achieved by means of the initially defined engine, characterized in that it comprises means for keeping the outlet valve open during at least a part of a compression stroke, wherein a closure of said outlet valve takes place at such a late stage during the compression stroke that a negative pressure is generated in the combustion chamber in relation to the pressure in the inlet during the following power stroke. Said means suitably comprises a computer program sequence stored on a memory, and a processor or the like for controlling the outlet valve in accordance with the inventive principle. Suitably, this control is primarily performed in connection with operational conditions during which an improvement of the preconditions for the use of a dynamic effect for a gas exchange in the combustion chamber is to be achieved. Furthermore, the engine comprises a means for registering the conditions under which the principle according to the invention is to be implemented. Furthermore, the engine preferably comprises a means, preferably computer program sequences, for the control of the inlet valve and the outlet valve in accordance with the above-described further embodiments of the inventive method.

Preferably, the invention may be combined with a supercharging that is accomplished by means of, for example, a mechanical compressor or a turbo aggregate.

Operable valves are referred to as valves to the combustion chamber of an engine cylinder, wherein said valves can be opened and closed by, for example, the action of a pressure fluid upon basis of signals from a control system, which is preferably of electronic type, and based on a computer program.

Further features and advantages of the present invention will be presented in the following description and in the remaining dependent patent claims.

### BRIEF DESCRIPTION OF THE DRAWINGS

Hereinafter, the invention will, by way of example, be described with reference to the annexed drawing on which:

FIG. 1 is a schematic representation of a part of a combustion engine according to the invention,

FIG. 2 is a representation of a normal operational sequence for a two stroke operation of a combustion engine, and

FIG. 3 is a representation of a time diagram for the steps of a preferred embodiment of the inventive method.

### DETAILED DESCRIPTION OF PREFERRED EMBODIMENT

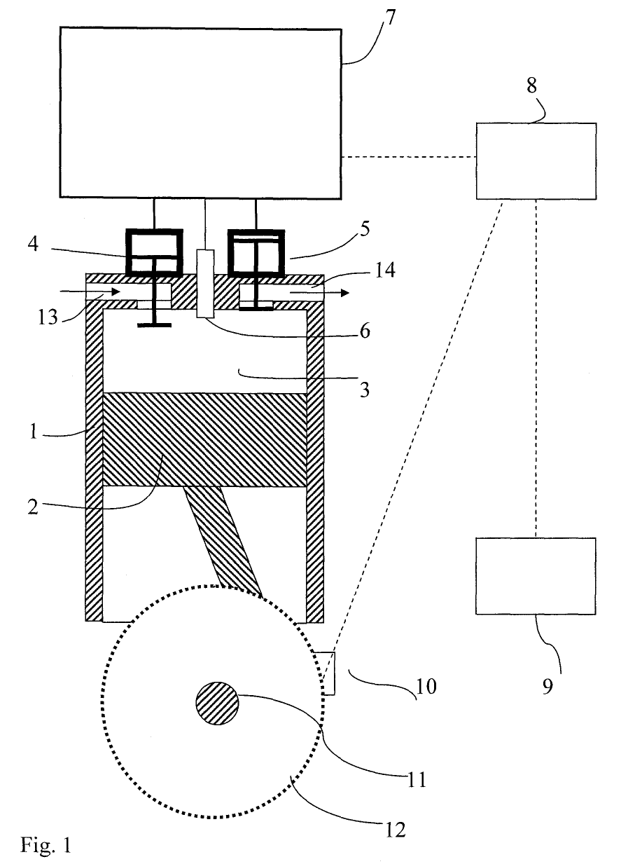

FIG. 1 schematically shows a part of a combustion engine according to the invention. The combustion engine comprises a cylinder 1, and a piston 2 arranged to move reciprocatingly in the latter, and a combustion chamber 3 delimited by the cylinder and the piston, an inlet valve 4, an outlet valve 5 and a valve or a nozzle 6 for the injection of a liquid other than fuel. It is also conceivable that the nozzle 6 be used in order, apart from injecting said liquid, to also inject at least a part of a fuel, for example an alcohol such as ethanol. The nozzle 6 may also be used only for the injection of fuel. An exhaust gas system or the like may be connected to the outlet at which the outlet valve 5 is arranged.

In FIG. 1, the piston 2 is under motion during a compression stroke of a two stroke cycle, and air, possibly together with fuel, is flowing into the combustion chamber through the open inlet valve 3. The outlet valve 4 has recently, when the piston 2 was in the lower dead centre, been open, but is now closed. This is the normal sequence during two stroke operation, i.e. an exchange of gas at the lower dead centre.

A circuit 7 is used for the operation of actuators to the valves 4 and 5 and to the nozzle 6. A control unit 8 is operatively connected to the circuit 7 in order to control, by means of signals, the circuit 7 and valves 4 and 5 respectively and the nozzle 6 connected to the circuit. The circuit 7 may comprise electric components and a pressure fluid circuit, preferably of a pneumatic type. For example, it may comprise pilot valves that are operated by means of electromagnets and provided for the purpose of controlling the flow, of a pressure fluid such as air to actuator chambers (not shown), for the purpose of acting on actuator pistons provided therein, by means of which pistons the inlet valves 4 and the outlet valves 5 are driven.

A member 9, for example a gas pedal, is operatively connected to the control unit 8 for the ordering of a torque. A sensor 10, adjacent to a graded plate 12 arranged on the crankshaft 11, is operatively connected to the control unit 8 and provides the control unit 8 continuously with information regarding engine speed and the crankshaft position and/or the position of the piston 2 in the cylinder 1. The control unit 8, or more precisely the software or the like with which the latter is provided, will decide when the operable valves 4 and 5 are to open or close, and when the nozzle 6 is to be opened for the injection of said liquid.

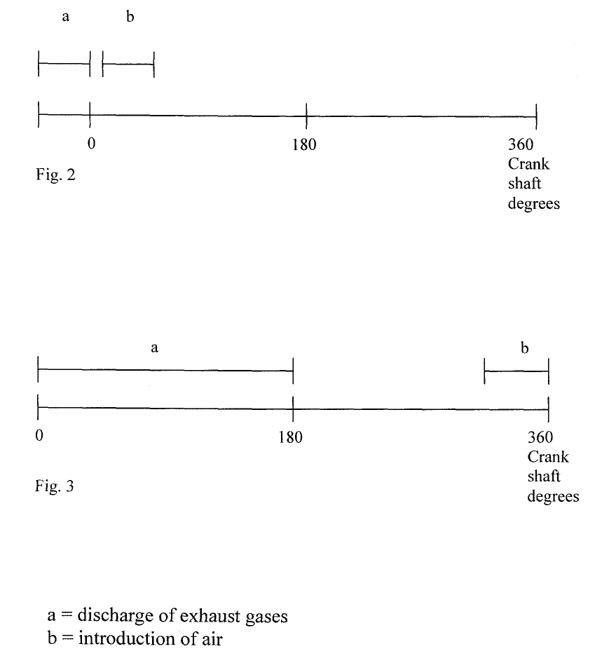

FIG. 2 shows a two stroke engine operating in normal operational mode. Thereby, as presented in FIG. 2, an evacuation of combustion gases and a supply of air, i.e. an exchange of gas, in accordance with the invention should be as follows. At the end of a power stroke, the outlet valve 5 is opened for the evacuation a of combustion gases that, in the form of a pulse, flow out of the combustion chamber 3 due to the pressure there being remarkably higher than the one in an exhaust gas or outlet channel 14 belonging to the exhaust gas system. As a result of said pulse, the pressure in the combustion chamber 3 will become lower than the one in the inlet channel 13 for the supply of air. When the spontaneous flow of gases out of the combustion chamber 3 ends, the pressure will be at a minimum, and, in a preferred embodiment, the outlet valve or valves 5 for the evacuation should be closed, whereafter the inlet valve or the inlet valves 5 should be opened for the introduction b of air as close as possible to said evacuation. Since the pressure in the combustion chamber 3 is remarkably lower than the pressure in the channel 13 for the introduction of air, air will flow in a pulse into the combustion chamber 3, and the pressure in the latter will increase. The pressure is at maximum just at the moment when the flow of air into the combustion chamber 3 spontaneously ends, and, in accordance with a preferred embodiment, the introduction of air should be ended by means of a closure of the inlet valve 4 as close to said moment as possible.

Herein, dynamic effect is referred to as the use of the above-described method with a pulse of combustion gases out of the combustion chamber 3, and to use the low pressure generated in the combustion chamber 3 in order to enable a pulse of air to the combustion chamber 3. However, the possibility of using the pulses is very temporary. Often, the pulses occur with a critical flow, the velocity of sound, which is the maximum velocity. It will be necessary, within a few thousands of a second, to be able to open and close the outlet valve 5 for the evacuation of the combustion gases from the combustion chamber 3, and to open and close the inlet valve 4 for the introduction of air to the combustion chamber 3. When the dynamic effect has been established, no further aid by any scavenging pump is needed in order to achieve a sufficient exchange of gas.

Contemporary two stroke engines must have a scavenging pump for the start of the engine and in order to rapidly achieve a high torque upon acceleration after engine braking. In order to reduce the speed of a vehicle by means of conventional technique, the supply flow of air is restricted or the channel for the introduction of air to the combustion chamber 3 is closed, whereupon the pressure in the combustion chamber 3, at the end of the power strokes, will be so low that the above-mentioned pulse of combustion gases out of the combustion chamber will not occur, resulting in the dynamic effects not being able to occur.

FIG. 3 shows a preferred embodiment of the method according to the invention. A characterizing feature for the invention is that, upon starting of the engine and acceleration after engine braking, and when a maximum torque is required, a dynamic effect can be rapidly established by the evacuation of possibly remaining combustion gases during the compression stroke, and by ending said evacuation in connection with the piston reaching its upper dead centre, and then, during the subsequent power stroke, when there is a desired negative pressure in the combustion chamber 3 in relation to the channel 13 for the introduction of air, the valve or the valves 4 for the introduction of b of air to the combustion chamber 3 is rapidly, i.e. temporarily, opened and then closed. During said power stroke, there is no ignition or combustion. Then, compression strokes and power strokes will follow as normally, with a different, preferably a conventional type of, opening sequence for the outlet valve, wherein the dynamic effects are maintained in a way as has been described previously for a two stroke engine during its operation.

A dynamic effect may, advantageously, be established during the operation of combustion engines of the pneumatic hybrid type, as compressed air during engine braking is stored in a tank and subsequently used during the subsequent acceleration.

Advantageously, a dynamic effect may also be established after expansion of steam that, in a hybrid in which power strokes generated by expanding combustion gases are alternated with power strokes generated by expanding steam, is produced by boiling water by means of exhaust gas heat. When steam of an adapted high pressure is accessible, the supply of said steam is performed before the initiation of the power stroke. At the end of the power stroke there is steam of enough pressure in order to establish a dynamic effect in accordance with the above disclosure.

In order to establish a dynamic effect by means of freely operable inlet and outlet valves 4, 5 it is important to be able to open and close the latter rapidly enough, and with enough area, for the evacuation of combustion gases, and for the supply of air in order to fill the combustion 3 with a maximum mass of air.

Contemporary freely operable valve openers are electromechanically, hydraulically or pneumatically activated. Pneumatically activated valves are able to achieve a predetermined lift height faster and with a lower consumption of energy than the other method, for a given mass that is not larger than necessary for the function in question. The period of time that goes between the opening of a valve of said mass to a certain lift height and the closure thereof can, by means of pneumatically activated valves, be substantially shorter than by means of the other methods. With reference to the need of being able to perform a valve motion as fast as possible, i.e. to open and close with a sufficient area, for the evacuation of combustion gases and for the supply of air for the best dynamic effect, pneumatically operated valves are preferred according to the invention.

In order to improve the dynamic effect, a characterizing feature of the invention is to use known principles in order to adapt the outlet channel for the combustion gases from the combustion chamber 3 and the channel for the supply of air to the combustion chamber 3 to the performance of the valve opener or the valve openers in question.

The dynamic effect means that a negative pressure is generated in the combustion chamber 3 in relation to the pressure in the channel 13 for supply of air. Another way of further lowering the pressure in the combustion chamber 3, that is characterizing for the invention, is to inject a liquid, preferably water, into the combustion chamber 3 when the flow of combustion gases out of the combustion chamber 3 is ended and when the supply of air or a mixture of fuel and air is to be initiated. For this purpose the combustion engine according to FIG. 1 is provided with a nozzle 6. The heat in the remaining combustion gases will generate a spontaneous evaporation of the liquid and a simultaneous cooling of the combustion gases, whereby the pressure in the combustion chamber 3 will decrease. Thereby, a larger mass of air can be supplied. Through the adaption of the mass of the supplied, injected liquid, the temperature can be controlled. This is of advantage during Homogeneous Charge Compression Ignition, HCCI. During HCCI, and upon large loads, the ignition may take place to early due to the temperature becoming to high. Another advantage of said evaporation of liquid and cooling is that the generation of nitrogen oxides, NO_{X}, during the combustion will be reduced to a substantial degree. When the liquid comprises water, the water steam has the same effect as exhaust gas recirculation, EGR, which is a usual method for suppressing the generation of NO_{X}. By means of the supplied mass of sprayed water, it will be possible to control the generation of NO_{X}. When diesel oil is used as the fuel, the generation of NO_{X} and soot can be suppressed, which is an advantage. Possibly remaining spray of water that has not been evaporated but that is evaporated doing the compression stroke will lower the compression work, as heat is thereby removed, resulting in an improved efficiency and a possible further suppression of the generation of NO_{X}.

The invention also relates to a computer program product stored on a readable computer program medium, for the implementation of the method according to the invention on a combustion engine according to the invention.

The invention is not delimited to a constant two stroke operation, but also includes embodiments in which a two stroke operation is alternated with a four stroke operation, or in which empty strokes, i.e. strokes without combustion, replace the ordinary power strokes. Thereby, the invention is to be implemented during the part of the operation during which there is a two stroke operation, or at least during a part thereof.

It should be realized that one and the same cylinder 2 may be provided with a plurality of inlet valves 4 and a plurality of outlet valves 5, and a plurality of nozzles 6 for the injection of liquid, all of which are, preferably provided in cylinder head. Since, preferably, the valves that are driven by means of pressure fluid are freely operable it may be possible to have an individual control of the valves, such that one of the valves of a pair of outlet valves 4 will open before and will close before or after the other valve of said pair. The discharge of exhaust gases will, in such a case, take part from the time of the first opening of any of said outlet valves until the last closure of any of said outlet valves. There is a corresponding relation for the inlet valves, and also for the injection nozzles if there is a plurality thereof.

1. A method for the operation of a combustion engine operating in accordance with a two stroke principle, which comprises alternating power strokes and compression strokes, wherein the combustion engine comprises at least one cylinder (1) and a piston (2) that moves reciprocatingly therein, and a combustion chamber (3) delimited by the cylinder (1) and the piston (2), and at least one inlet (13) for the introduction of combustion air into the combustion chamber (3), and at least one outlet (14) having freely operable outlet valve (5) for the discharge of exhaust gases from the combustion chamber (3), characterized in that the outlet valve (5) is kept open during at least a part of a compression stroke, wherein a closure of the outlet valve (5) is performed at such a late stage during the compression stroke that there is generated a negative pressure in the combustion chamber (3) in relation to the pressure in the inlet (13) during the subsequent power stroke.

2. A method according to claim 1, characterized in that the outlet valve (5) is closed during the later half of said compression stroke.

3. A method according to claim 1, characterized in that the outlet valve (5) is closed during the last fourth of said compression stroke.

4. A method according to claim 1, characterized in that the outlet valve (5) is closed at the end of said compression stroke.

5. A method according to claim 1, characterized in that the outlet valve (5) is closed at the moment when the flow of exhaust gases out of the combustion chamber spontaneously ends.

6. A method according to claim 1, characterized in that the outlet valve (5) is opened at the beginning of said compression stroke.

7. A method according to claim 1, characterized in that the inlet (13) is opened during the power stroke that follows said compression stroke, for the introduction of air into the combustion chamber.

8. A method according to claim 7, characterized in that the inlet (13) is closed during the power stroke that follows said compression stroke.

9. A method according to claim 7, characterized in that the inlet (13) is provided with an inlet valve (4) that is closed at the moment when the flow of air into the combustion chamber (3) spontaneously ends.

10. A method according to claim 1, characterized in that the outlet valve (5) is kept opened during at least a part of compression stroke in connection with operational conditions by which an improvement of the preconditions for the use of a dynamic effect for the exchange of gases in the combustion chamber (3) is to be established.

11. A method according to claim 1, characterized in that said operational conditions include at least one of engine start or acceleration after engine braking.

12. A method according to claim 1, characterized in that said inlet valves (4) and outlet valves (5) are pneumatically driven.

13. A combustion engine operating in accordance with the two stroke principle, said principle comprising alternating power strokes and compression strokes, wherein the combustion engine comprises at least one cylinder (1) and a piston (2) that moves reciprocatingly in said cylinder, and a combustion chamber (3) delimited by said cylinder (1) and piston (2), and at least one inlet (13) for the introduction of combustion air into the combustion chamber (3), and at least one outlet (14) provided with a freely operable outlet valve (5) for the discharge of exhaust gases from the combustion chamber (3), characterized in that it comprises means (7-12) for holding the outlet valve (5) open during at least a part of a compression stroke, whereby the closure of the outlet valve (5) is performed at such a late stage during the compression stroke that there will be a negative pressure in the combustion chamber (3) in relation to the pressure in the inlet (13) during the following power stroke.
